(19) United States
(12) Patent Application Publication
(10) Pub. No.: US 2004/0172370 A1
(43) Pub. Date: Sep. 2, 2004

(54) Verfication of access compliance of subjects with objects in a data processing system with a security policy

(76) Inventors: Christophe Bidan, La Chapelle des Fougeretz (FR); Mireille Pauliac, Aubagne (FR)

Correspondence Address: BURNS DOANE SWECKER & MATHIS L L P, POST OFFICE BOX 1404, ALEXANDRIA, VA, 22313-1404, US

(21) Appl. No.: 10/471,566

(22) PCT Filed: Mar. 8, 2002
(86) PCT No.: PCT/FR02/00844

(30) Foreign Application Priority Data
Mar. 13, 2001 (FR) 01 03486

(51) Int. Cl. H04K 1/00

(52) U.S. Cl. 705/75

(57) ABSTRACT

The invention relates to access rules (R) of compliance of subjects (Su) with objects (Ob) with a predetermined security policy (PS) in a data processing system such as a chip card. Each access rule defines the right of a subject to carry out an action on an object The security policy defines the security rules (RS) for access of the subjects to the objects. For an operation relating to a given object (Ob), at least one access rule relating to the given object is compared with the security rules in order to accept the operation when the access rule is in compliance with all the security rules; if this is not the case, the operation is refused. An operation can be the loading of an object such as an application, a modification of the access rules, or deletion or addition of a subject (s) or a request for access to a given object by a subject or a group of subjects.

The present invention relates in general terms to verification of the compliance of conditions of access by first elements to second elements with security rules defining a security policy. The first elements are subjects constituting users or software modules of a data processing means. The second elements are objects such as applications implemented in the data processing means. More particularly, the invention relates to conditions of access to applications implemented in a smart card, also referred to as a microprocessor card or integrated circuit card, which comprises a number of applications relating to various services, such as electronic commerce, electronic purse or loyalty service applications, etc.

The invention is thus particularly directed towards the compliance of any operation relating to an application in a multi-application smart card with security rules. The operation can be loading or modification of the application, or modifications of the conditions of access to the application, or else a request for access to the application in order to perform an action thereon.

The coexistence and cooperation of a number of applications within the same smart card raises many problems from the security point of view. In particular, each application has its own data for which the supplier of the application defines access rights specific to the application. The access rights are means of connection between external accesses which can be users of the card or software modules, such as user interfaces, and accesses internal to the card such as applications, possibly through the intermediary of other applications or other software application elements in the card.

Control of access conditions is based on authentication of the subjects, such as the users, which are “active” elements which manipulate information contained in objects, such as applications, which are “passive” elements containing data. The access rights of the subjects to the objects are governed by access control rules between the subjects and the objects. Each rule comprises an access right, that is to say a link between a subject and an object in the form of an action which can be performed by the subject on the object.

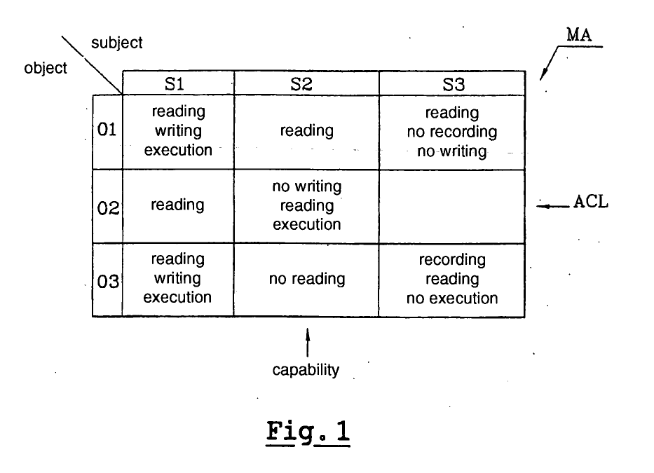

It is known to represent the access rights of subjects to objects by an access matrix MA whose columns correspond to subjects and whose rows correspond to objects, as shown in FIG. 1. For example, the matrix MA relates to three subjects S1, S2 and S3, such as three users, and to three objects O1, O2 and O3, such as files and programs. Each cell of the matrix at the intersection of a row and a column contains access rights, that is to say privileged actions which can be performed by the respective subject on the respective object.

The access rights can be positive in order to authorise a predetermined action of a subject on an object, or negative in order to prohibit a predetermined action of a subject on an object. For example, the subject S2 can read and execute the object O2 but cannot write into this object, and the subject S3 can record and read the object O3 but cannot execute the object O3.

As is known, access control rules are generally handled according to two approaches.

The first approach consists of Access Control Lists (ACL) corresponding to the rows of the access matrix MA and each specifying the access rights of subjects to the object associated with the row. By way of example, in a multi-application smart card of the Windows (registered trademark) type, access control lists ACL define user accesses to files included in the card.

Conversely, the second approach consists of capabilities corresponding to the columns of the matrix MA and each specifying the access rights of the subject associated with the column on the objects. For example, access control is concerned with applet techniques for JavaCard type multi-application smart cards in which programs in Java language have been written. The capabilities are in the form of pointers allowing calls to be made to objects, in predetermined applets constituting subjects.

In the microcontroller card field, the notion of security policy is generally omitted. This is because, with the cards being until then generally single-application, this dictates a single security policy of reasonable size for ensuring that the access rights correctly correspond to the wish of the developer responsible for defining the access rights.

As already specified, access rights are expressed in the form of access control rules. It is then necessary to verify and guarantee that the access rights are complete and consistent with regard to a policy, that is to say they provide at least two properties, completeness and consistency. Access right completeness ensures that, for any subject and any object, there exists at least one access right specifying whether or not the subject is authorised to access the object. Consistency of access rights guarantees that, for any subject and any object, if a number of access rights to the object are defined, the access rights all specify the same type of right, either positive or negative. Completeness of access rights with regard to a security policy ensures that the access rights define all the rights specified by the security policy. Consistency of access rights with regard to a policy ensures that the access rights are limited to those defined by the security policy and do not define more rights.

At present in multi-application cards, the properties of completeness and consistency of access rights with a security policy cannot be verified. The developer responsible for defining the access rights is therefore not in a position to verify that the specified access rights correspond to the rules of the desired security policy.

The introduction of multi-application cards complicates the problem of the coexistence of a number of applications and therefore the coexistence of a number of security policies, cooperation between the applications further increasing policy complexity.

The objective of the present invention is to provide a method for verifying the compliance of the access rights of a number of subjects to a number of objects, such as applications in a multi-application card, with a global security policy which is implemented by the manager of the card who can be a different person from the developer of each of the applications. This method thus guarantees the completeness and consistency of the access rights with regard to a security policy: the access rights define all the rights specified by the security policy according to the completeness property, and are limited to these security policy rights according to the consistency property.

In order to achieve this objective, a method for verifying a set of rules for access of first elements to second elements in a data processing system, each rule defining a right of a first element to perform an action on a second element, is characterised in that it comprises a definition of security rules for the access of the first elements to the second elements and, for each operation relating to a given second element, a comparison of at least one given rule for access to the given second element with the security rules so as to accept the operation when the access rule complies with all the security rules and to signal non-compliance of the operation when the access rule does not comply with one of the security rules.

As will be seen subsequently, the first elements are for example subjects, such as users, and the second elements are for example objects, such as applications in a multi-application smart card included in the data processing system.

According to a first embodiment, the data processing system comprises a portable electronic object in which at least the second elements are located, and a security means external to the portable electronic object in which the security rules are located and which performs the comparison.

According to a second embodiment, the data processing system is a portable electronic object in which at least the second elements and the security rules are located and which performs the comparison.

Other characteristics and advantages of the present invention will emerge more clearly from a reading of the following description of a number of preferred embodiments of the invention with reference to the corresponding accompanying drawings in which:

FIG. 1 is a diagram showing a matrix for control between three subjects and three objects, already commented upon, according to the prior art;

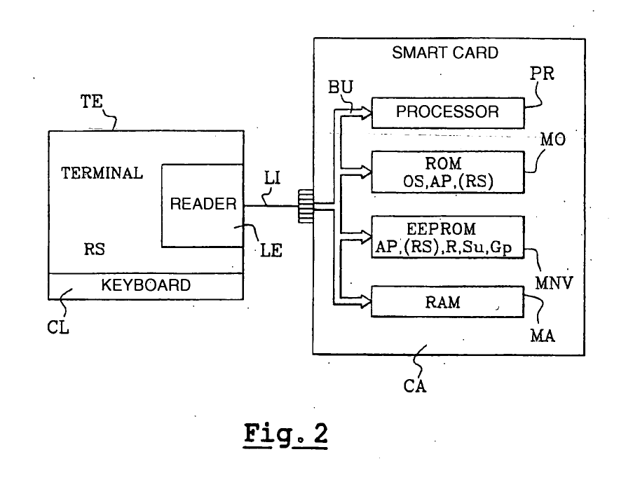

FIG. 2 is a schematic block diagram of a data processing system for implementing the compliance is control method according to a first embodiment of the invention; and

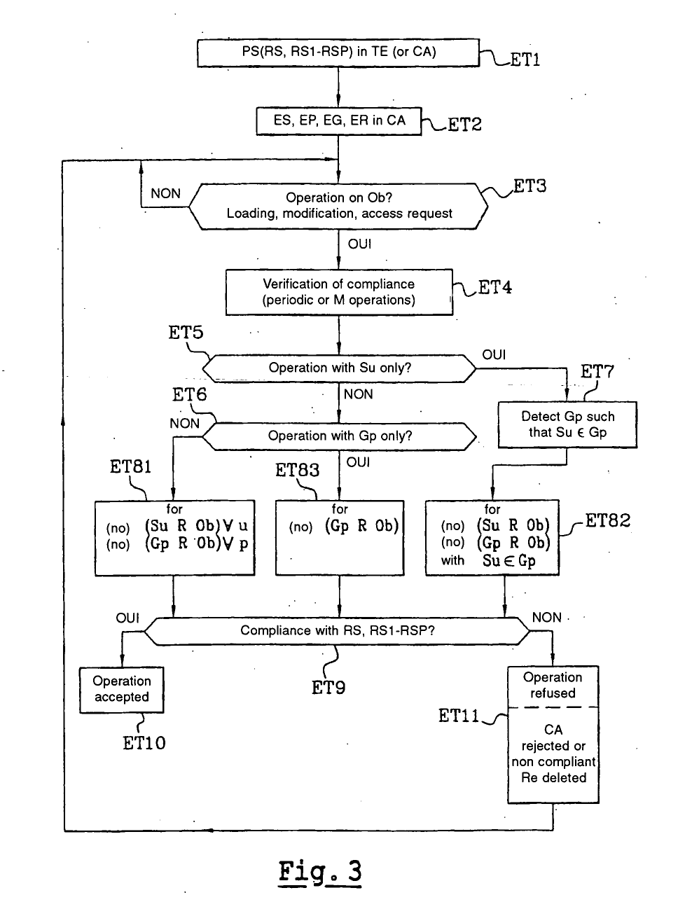

FIG. 3 is an algorithm of the compliance verification method according to the invention.

An electronic data processing system as illustrated in FIG. 2 comprises a portable electronic object such as a smart card CA and a terminal TE provided with a keyboard CL and a reader LE for reading the data in the card. The “chip” of the card CA is a microcontroller comprising a microprocessor PR and three memories MO, MNV and MA. The ROM type memory MO includes an operating system OS for the card. The memory MNV is a non-volatile memory of programmable and erasable type, such as an EEPROM memory. The memory MNV contains data in particular linked to the holder and the supplier of the card and in particular applications AP constituting objects in the sense of the invention and data linked to accesses to the applications AP, such as access rules R and subjects Su. The memory MA is of RAM type and intended to receive in particular data from the terminal TE of the card. All the components PR, MO, MNV and MA are interconnected by an internal bus BU. When the card CA is inserted into the reader LE of the terminal TE, the bus BU is connected to the terminal TE through a contact link LI when the card is of the type with electrical contacts.

According to this first embodiment, a security policy defined by security rules RS relating to all the applications AP in the smart card CA is pre-stored in the terminal TE. For example, the terminal TE belongs to the distributor of the smart card who can be different from each application developer responsible for defining rules for access to at least one respective application.

In a variant, the terminal containing the security rules and verifying compliance of the access rules with the security rules is a server connected by a telecommunication network to a reception terminal of the smart card.

According to a second embodiment, instead of the security policy PS being located in the terminal TE, the security rules RS defining the security policy are located in the ROM memory MO of the smart card CA which constitutes the data processing system.

The following description of the compliance verification method according to the invention is valid equally well for these two embodiments presented above.

The embodiments described below of the method for verifying compliance of access of subjects to objects with a security policy refer to the following five sets:

an object set EO={O1, . . . Ob, . . . OB} with 1≦b≦B;

a subject set ES={S1, . . . Su, . . . SU} with 1≦u≦U relating to subjects each having at least one access to a given object Ob;

a subject group set EG={G1, . . . Gp, . . . GP} relating to subjects each having at least one access to the object Ob, a subject in a group having all the access rights granted to this group, and a subject being able to belong to one or more groups;

an access right rule set ER={R1, . . . Re, . . . RE} with 1≦e≦E governing the access of the subjects of the set ES and the groups of the set EG to the given object Ob; and

a set of security rules RS applicable to all the subjects in the set giving access to the object Ob and of security rules RS1 to RSP applicable respectively to the groups G1 to GP for accessing the object Ob.

If R (or RS) designates a right, that is to say an action such as reading, writing, execution or recording, which can be performed by any subject whatsoever Su on any given object whatsoever Ob, access control is governed by the following positive right rules:

(SuROb): the subject Su has the right R on the object Ob, that is to say is authorised to perform the action R on the given object Ob;

(GpROb): the subjects in the group Gp have the right R on the object Ob;

and by the following negative right rules:

no(SuROb): the subject Su does not have the right R on the given object Ob, that is to say is prohibited from performing the action R on the object Ob;

no(GpROb): the subjects in the group Gp do not have the right R on the object Ob.

Subsequently, a right obtained directly by the rule (SuROb), that is to say without passing through the intermediary of a group, will be referred to as a “direct right” of the subject Su on the object Ob; and a right obtained by the rule (GpROb) through a group Gp in which the subject Su is included will be referred to as an “indirect right” of the subject Su on the object Ob.

With reference now to FIG. 3, the compliance verification method comprises principally steps ET1 to ET8.

At the start of the method, a first initial step ET1 defines a security policy PS which comprises security rules RS which are common to all the objects O1 to OB of the set EO as well as security rules respectively for predetermined subject groups and predetermined objects, and in particular for the groups G1 to GP associated with the given object Ob. The security policy is located in the terminal TE, or in the memory MNV of the smart card CA.

The second initial step ET2 defines the four groups ES, EO, EG and ER in order to implement them in the memories MO and MNV of the smart card CA.

The following step ET3 relates to the initiation of an operation on the given object Ob. This operation can be the loading of the given object Ob, for example as a new application, into the EEPROM memory MNV of the card CA, including the access rules specific to the application defined at a previous step ET2 and written into the memory MNV, or an access rule modification relating to the given object Ob. The access rule modification can be a deletion or an addition of an access rule relating to a subject Su or a group Gp and naturally to the given object Ob. The operation on the given object Ob can be simply a request for an access right to the given object by a subject Su or a group Gp of the (SuROb) or (GpROb) type, or modification of one or more subjects or of a group having an access to the given object Ob, that is to say a deletion or an addition of one or more subjects or of a group.

Compliance verification proper by comparing access rules relating to the given object Ob with all the security rules begins at the step ET4. In a variant, this compliance verification is performed periodically for example every twenty-four hours when the smart card CA is used, or else every M operations relating to the given object Ob, where M designates an integer equal to at least 2.

In general terms, according to a first embodiment, all the positive and negative access rules Re relating to the given object Ob and to any subject whatsoever Sq for a direct right or to any group whatsoever Gp for an indirect right have their compliance verified with respect to all the security rules RS and RSp irrespective of the index p defined by the security policy for the object Ob, as indicated at steps ET81, ET82, ET83 and ET9 which then follow the step ET4 directly through a negative reply at the intermediate step ET6 or after the step ET7. In practice, verification of the compliance of an access rule is the result of a comparison of this rule with each of the security rules. For example, a security rule common to all the subjects and all the groups relating to the object Ob can be a prohibition from writing to the object Ob, and a security rule RSp for the group Gp can be an authorisation for reading the given object Ob by all the subjects belonging to the group Gp.

However, according to other embodiments, the method distinguishes operations relating solely to a subject Su, such as a request for direct access from the subject Su to the object Ob or addition of the subject Su, at the step ET5, and an operation relating solely to a given group Gp, such as a request for indirect right access to the given object Ob or a subject addition or deletion or a right modification relating to the group Gp, as indicated at the step ET6. If none of the conditions of the steps ETS and ET6 is satisfied, the method goes directly from the step ET4 to the step ET81 already commented upon.

When the operation relates solely to a subject Su (and to the object Ob, the step ET5 is followed by a step ET7 during which all the groups Gp which contain the subject Su are detected. In this embodiment, the step ET81 is replaced by the step ET82 which verifies the compliance of all the positive and negative access rules relating to the given object Ob and directly to the subject Su or indirectly to the groups Gp containing the subject Su. These access rules are compared with all the common security rules RS and the security rules RS1 to RSp and in particular relating to the group Gp at the step ET9. By means of the steps ET7 and ET82, the method thus verifies that the capability of a subject Su relating to the given object Ob complies with the security policy PS.

When the operation on the given object Ob relates solely to a subject group Gp at the step ET6, all the access right rules of positive (GpROb) and negative no(GpROb) type have their compliance verified by comparison with all the common security rules RS and the security rules RS1 to RSp relating to all the groups, and particularly relating to the given group Gp, at a step ET83. Through the steps ET6 and ET83, the method thus verifies that the access control list relating to all the access rights of the subjects in a given group Gp is in compliance with the security policy PS.

If, after the step ET81, or ET82 or ET83, the access rules compared comply correctly with the security rules, the operation requested at the step ET3 is accepted at the step ET10, and the method returns to the step ET3 for a compliance verification relating to another operation on the object Ob, or to an operation on another object.

On the other hand, if at least one of the access right rules compared and defined at one of the steps ET81, ET82 and ET83 does not comply with one of the security rules at the step ET9, the step ET11 refuses the operation requested at the step ET3, and the method then returns to the step ET3. Refusal of the operation requested at the step ET11 can be accompanied by rejection of the smart card CA, or by deletion of the access right rule or rules which did not comply with the security rules.

By way of example, it is assumed that a first group G1 consisting of subjects S1 and S2 possesses only a read access right on the given object Ob, a second group G2 consisting of subjects S2 and S3 possesses only a write access right on the object Ob, and the two groups G1 and G2 are authorised to execute the object Ob such as an application. Furthermore, the step ET1 defines two security rules RS1 and RS2. According to the first rule RS1, the group G1 is not authorised to write to the objects in the set EO, and therefore including to the given object Ob. According to the second security rule RS2, the group G2 is not authorised to read the objects in the set EO.

For this example, the steps ET6 and ET83 of the method according to FIG. 3 are performed. A request for read access of the group G1 reveals at the step ET9 a compliance for the subject S1 belonging solely to the group G1 between the read access rule of the group G1 and the security rule prohibiting writing of the group G1, and a compliance for the subject S3 between the write access right rule of the group G2 and the security rule prohibiting reading of the group G2. On the other hand, the step ET9 signals a compliance failing for the subject S2 which belongs to both groups G1 and G2. For the subject S2 the read access right rule relating to the group G1 does not comply with the security rule prohibiting reading for the group G2, and the write access right rule for the group G2 does not comply with the security rule prohibiting writing of the group G1. The step ET11 then deletes the read and write access rights of the subject S2 which retains only the execution access right in common with the other subjects S1 and S3.

Although FIG. 3 relates to the compliance of operations on a given object Ob, more generally, any operation relating to any whatsoever of the objects O1 to OB in the set EO can cause a general compliance verification of all the access control lists and capabilities relating to all the objects O1 to OB with respect to all the security rules of the security policy. Such a general compliance verification is preferably carried out at least during commissioning and personalisation of the smart card CA.

1. A method for verifying the compliance of access rules (Re) defining respectively rights authorising and/or prohibiting first elements (Su), such as users, to carry out/from carrying out actions on second elements (Ob), such as applications located in a portable electronic object (CA), with security rules (RS) limiting the rules for access of the first elements to the second elements, characterised in that it comprises, for each operation (ET3) relating to a given second element (Ob), such as in particular loading of the given second element (Ob) or an access rule modification relating to the given second object in the portable electronic object (CA), a comparison (ET81, ET82, ET83, ET9) of at least one rule for access (Su/GpROb) to the given second element with the security rules (RS) so as to accept (ET10) the operation when the said access rule (R) complies with all the security rules and to signal non-compliance of the operation when the said access rule does not comply with one of the security rules.

2. A method according to claim 1, in accordance with which the said operation (ET3) is either a deletion or an addition of an access rule (R) relating to the given second element, or a deletion or an addition of a first element (Su) or of a number of first elements (Gp) having access to the given object (Ob), or a request for access to the given object (Ob) by a first element (Su) or by a first-element group (Gp).

3. A method according to claim 1, in accordance with which, when the operation (ET5) relates solely to a given first element (Su) and to the given second element (Ob), the comparison (ET82) consists of comparing all the access rules (SuROb, Gp(Su)ROb) relating to the given first element (Su) and to the given second element (Ob) with all the security rules (RS).

4. A method according to claim 1, in accordance with which certain of the first elements each belong to one or more first-element groups (Gp), a first element in a group having all the access rights granted to the group, characterised in that, when the operation (ET6) relates to a given first-element group (Gp), the comparison (ET83) consists of comparing all the access rules (GpROb) relating to the given group and to the given second element (Ob) with all the security rules (RS).

5. A method according to any one of claims 1 to 4, in accordance with which the comparison (ET81, ET82, ET83, ET9) is performed periodically.

6. A method according to any one of claims 1 to 5, in accordance with which the security rules (RS) are located in a security means (TE) which is external to the portable electronic object (CA) and which performs the comparison (ET81, ET82, ET83, ET9).

7. A method according to any one of claims 1 to 5, in accordance with which the security rules (RS) are located in the portable electronic object (CA) which performs the comparison (ET81, ET82, ET83, ET9).
